(19) United States
(12) Patent Application Publication
(10) Pub. No.: US 2011/0148830 A1
(43) Pub. Date: Jun. 23, 2011

(54) Gate Driving Circuit

(75) Inventors: Chao-Ching HSU, Hsin-Chu (TW); Jen-Chieh Chen, Hsin-Chu (TW); Chen-Lun Chiu, Hsin-Chu (TW)

(73) Assignee: AU Optronics Corp.

(21) Appl. No.: 12/757,966

(22) Filed: Apr. 9, 2010

(30) Foreign Application Priority Data
Dec. 17, 2009 (TW) 098143397

(51) Int. Cl. G09G 5/00

(52) U.S. Cl. 345/205

(57) ABSTRACT

An exemplary gate driving circuit is formed on a substrate and includes a plurality of shift register stages successively arranged on the substrate along a predetermined direction. The shift register stages are grouped into a plurality of groups and for outputting a plurality of gate driving signals. Each of the groups includes a plurality of cascade-connected the shift register stages. Time sequences of a plurality of start pulse signals inputted into the groups are different from one another. An output order of the gate driving signals is different from the arranging order of all the shift register stages.

### CROSS-REFERENCE TO RELATED APPLICATIONS

This application is based upon and claims the benefit of priority from the prior Taiwan Patent Application No. 098143397, filed Dec. 12, 2009, the entire contents of which are incorporated herein by reference.

U.S. application Ser. No. 12/607,042 filed on Oct. 27, 2009 which claims priority from Taiwan Patent Application No. 098111706 is co-pending with this application.

### BACKGROUND

1. Technical Field

The present invention generally relates to display technology fields and, particularly to a gate driving circuit.

2. Description of the Related Art

Nowadays, flat display devices such as liquid crystal displays have many advantages of high display quality, small volume, lightweight and wide application range and thus are widely used in consumer electronics products such as mobile phones, laptop computers, desktop computers and televisions, etc. Moreover, the liquid crystal displays have evolved into a mainstream display in place of cathode ray tube (CRT) displays.

In order to make the display products become more miniaturized and cost competitive, a gate on array (GOA) circuit has been proposed as a kind of gate driving circuit to generate gate pulse signals. The GOA circuit conventionally includes a plurality of cascade-connected shift register stages for sequentially generating a plurality of gate pulse signals. An output of each of the shift register stages acts as a start pulse signal of the next shift register stage.

However, in regard to the gate driving circuit associated with the prior art, the cascade-connected shift register stages only can generate the gate pulse signals in sequential mode because of the limitation at the aspect of circuit design. In one aspect, when the conventional gate driving circuit is used in a half source driving (HSD) display, a vertical line mura would occur in the situation of pre-charge function being required, which will result in uneven display brightness. In another aspect, the conventional gate driving circuit would not be applied to interlace displays so that the application range is limited.

### BRIEF SUMMARY

Accordingly, the present invention is directed to a gate driving circuit, so as to address the issues associated with the prior art.

In order to achieve the above-mentioned objective, or to achieve other objectives, a gate driving circuit in accordance with an embodiment of the present invention is provided. The gate driving circuit is formed on a substrate and includes a plurality of shift register stages successively arranged on the substrate along a predetermined direction. The shift register stages are grouped into a plurality of groups and for outputting a plurality of gate driving signals (e.g., single-pulse gate driving signals). Each of the groups includes a plurality of cascade-connected the shift register stages. Time sequences of a plurality of start pulse signals inputted into the respective groups are different from one another. An output order of the gate driving signals is different from the arranging order of all the shift register stages.

In one embodiment, all the shift register stages constitute a plurality of repeating units in the predetermined direction, wherein the repeating units are successively arranged along the predetermined direction. Each of the repeating units includes one of the cascade-connected shift register stages of each of the groups.

In one embodiment, each of the groups uses multi-phase clock signals. The multi-phase clock signals used by each of the groups are different from the multi-phase clock signals used by any one of the other group(s).

In one embodiment, the amount of the groups is two, and the multi-phase clock signals used by each of the two groups are two-phase clock signals. Correspondingly, when the gate driving circuit is applied to a HSD display, priority orders of the start pulse signals inputted into the two groups are interchanged one time during the HSD display displaying each two adjacent image frames; when the gate driving circuit is applied to an interlace display, one of the start pulse signals is disabled to input during the interlace display displaying each image frame.

In one embodiment, the amount of the groups is two, and the multi-phase clock signals used by each of the two groups are three-phase clock signals. In an alternative embodiment, the amount of the groups is three, and the multi-phase clock signals used by each of the three groups are two-phase clock signals.

In one embodiment, all the shift register stages constitute a plurality of first repeating units and a plurality of second repeating units in the predetermined direction. The first repeating units and the second repeating units are arranged in an alternating manner along the predetermined direction. Each of the first and second repeating units includes one of the cascade-connected shift register stages of each of the groups. A relative positional relationship of the shift register stages of each of the first repeating units and belonging to the respective groups is different from a relative positional relationship of the shift register stages of each of the second repeating units and belonging to the respective groups. Moreover, the amount of the groups can be two, and each of the two groups uses two-phase clock signals. Correspondingly, when the gate driving circuit is applied to a HSD display, priority orders of the start pulse signals inputted into the respective groups are interchanged one time during the HSD display displaying each two adjacent image frames.

In order to achieve the above-mentioned objective, or to achieve other objectives, a gate driving circuit in accordance with another embodiment of the present invention is provided. The gate driving circuit is formed on a substrate and includes a plurality of shift register stages. The shift register stages are successively arranged on the substrate along a predetermined direction and grouped into a plurality of groups. Each of the groups includes a plurality of cascade-connected the shift register stages. The groups respectively use a plurality of externally inputted start pulse signals, and a priority order of the start pulse signal used by each of the groups relative to another one of the start pulse signals used by any one of the other group(s) is adjustable. Moreover, each of the groups and any one of the other group(s) do not use the same clock signal.

In summary, the shift register stages of the gate driving circuit in the above-mentioned embodiments of the present invention are grouped, the start pulse signal and multi-phase clock signals used by one of the groups respectively are mutually independent from that used by any one of the other group(s), therefore the user can flexibly adjust the priority orders of the start pulse signals inputted into the respective groups or disable one of the start pulse signals. Accordingly, when the gate driving circuit proposed by the present invention is applied to a HSD display, the vertical line mura associated with the prior art can be effectively relieved. Furthermore, the application range of the gate driving circuit proposed by the present invention can expand to interlace displays.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic circuit diagram of a gate driving circuit in accordance with an embodiment of the present invention.

FIGS. 2 and 3 are timing diagrams of multiple signals associated with the gate driving circuit of FIG. 1 being applied to a HSD display.

FIGS. 4(a) and 4(b) show display states of a HSD display using the gate driving circuit of FIG. 1.

FIGS. 5 and 6 are timing diagrams of multiple signals associated with the gate driving circuit of FIG. 1 being applied to an interlace display.

FIG. 7 is a schematic circuit diagram of a gate driving circuit in accordance with another embodiment of the present invention.

FIGS. 8 and 9 are timing diagrams of multiple signals associated with the gate driving circuit of FIG. 7 being applied to a HSD display.

FIGS. 10(a) and 10(b) show display states of a HSD display using the gate driving circuit of FIG. 7.

FIG. 11 is a schematic circuit diagram of a gate driving circuit in accordance with still another embodiment of the present invention.

FIG. 12 is a schematic circuit diagram of a gate driving circuit in accordance with even still another embodiment of the present invention.

### DETAILED DESCRIPTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” “vertical,” etc., is used with reference to the orientation of the Figures being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Accordingly, the drawings and descriptions will be regarded as illustrative in nature and not as restrictive.

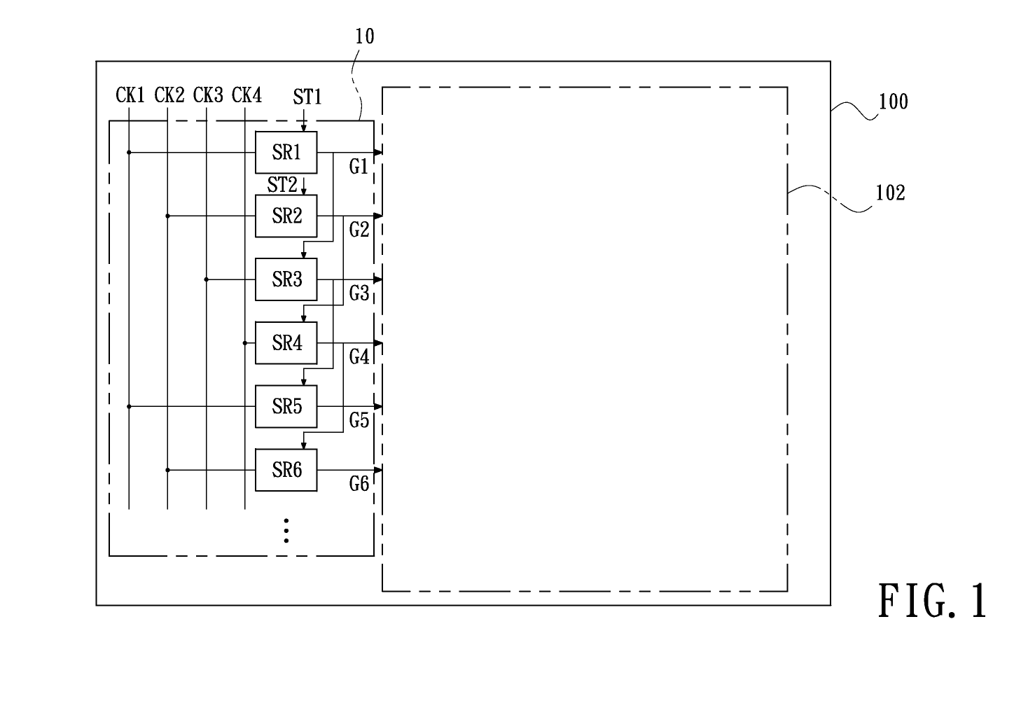

Referring to FIG. 1, a gate driving circuit 10 in accordance with an embodiment of the present invention is formed on a substrate 100. The substrate 100 generally has a thin film transistor array 102 formed thereon. As illustrated in FIG. 1, the gate driving circuit 10 includes a plurality of shift register stages e.g., SR1˜SR6 successively arranged along the vertical direction and for outputting a plurality of gate driving signals e.g., G1˜G6. The shift register stages SR1˜SR6 are grouped into two groups. The shift register stages SR1, SR3 and SR5 belong to a first group of the two groups and herein are referred to as first shift register stages for convenience of description. The shift register stages SR2, SR4 and SR6 belong to a second group of the two groups and herein are referred to as second shift register stages. The first shift register stages SR1, SR3, SR5 and the second shift register stages SR2, SR4, SR6 are arranged in alternating fashion and cooperatively constitute a plurality of repeating units successively arranged along the vertical direction. Each of the repeating units includes one of the first shift register stages (e.g., SR1) and one of the second shift register stages (e.g., SR2).

The first group of shift register stage uses a start pulse signal ST1 and two-phase clock signals CK1, CK3. The first shift register stages SR1, SR3, SR5 belonging to the first group are connected in cascade. The second group of shift register stage uses a start pulse signal ST2 and two-phase clock signals CK2, CK4. The second shift register stages SR2, SR4, SR6 belonging to the second group are connected in cascade. In other words, the start pulse signal ST1 and the two-phase clock signals CK1, CK3 inputted into the first group of shift register stage respectively are mutually independent from the start pulse signal ST2 and the two-phase clock signals CK2, CK4 inputted into the second group of shift register stage. Moreover, as illustrated in FIG. 1, the start pulse signals ST1, ST2 are respectively for enabling the first group of shift register stage and the second group of shift register stage.

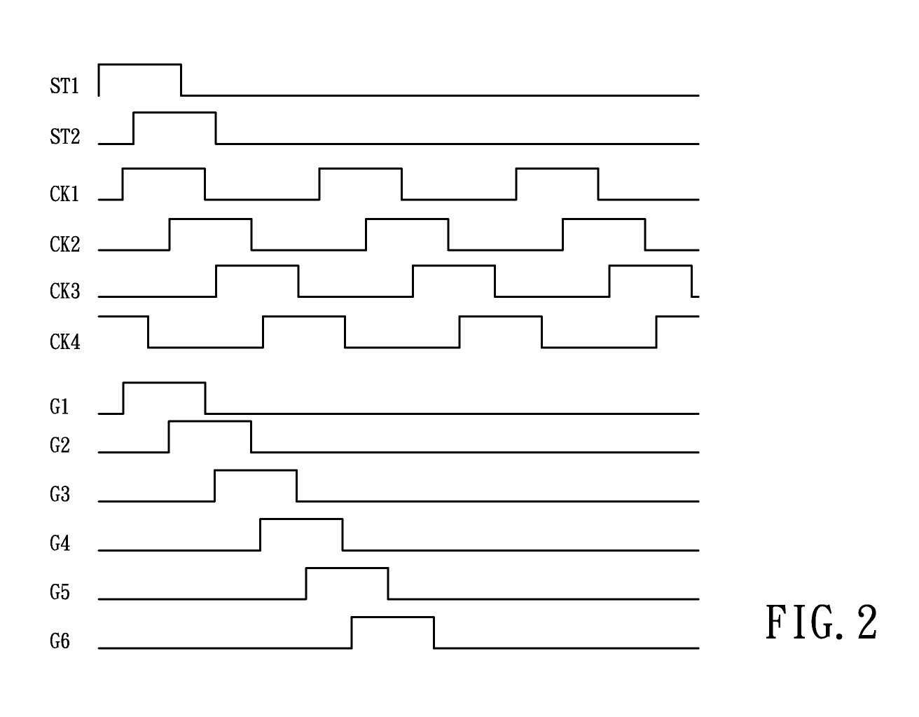

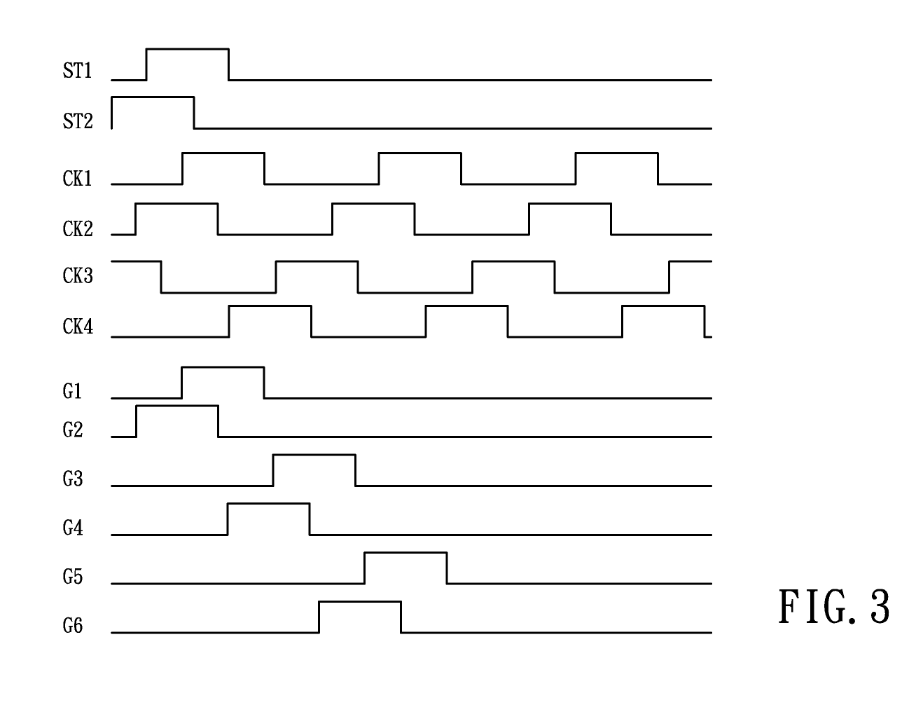

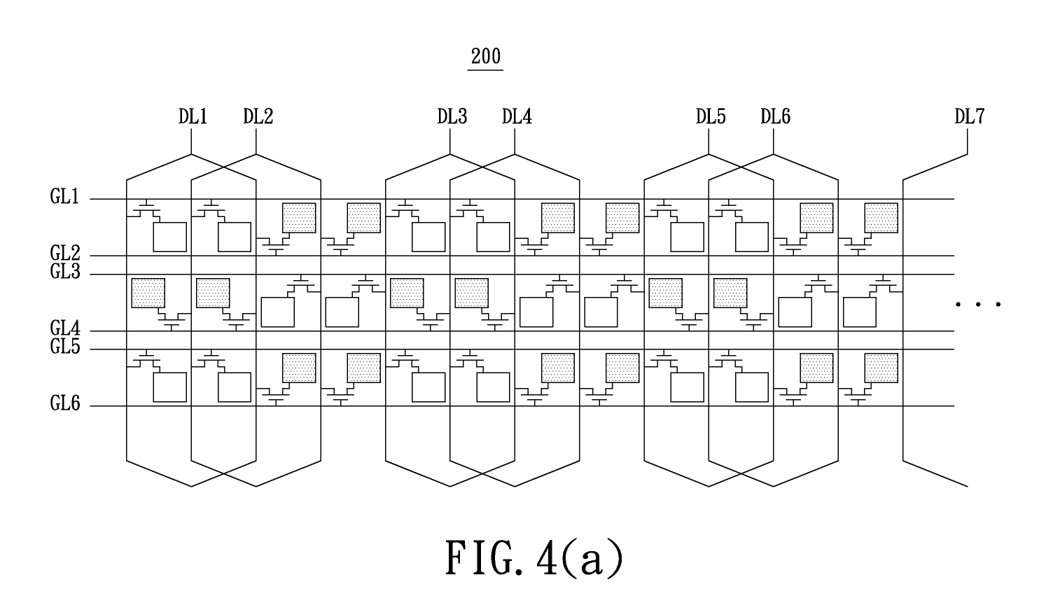

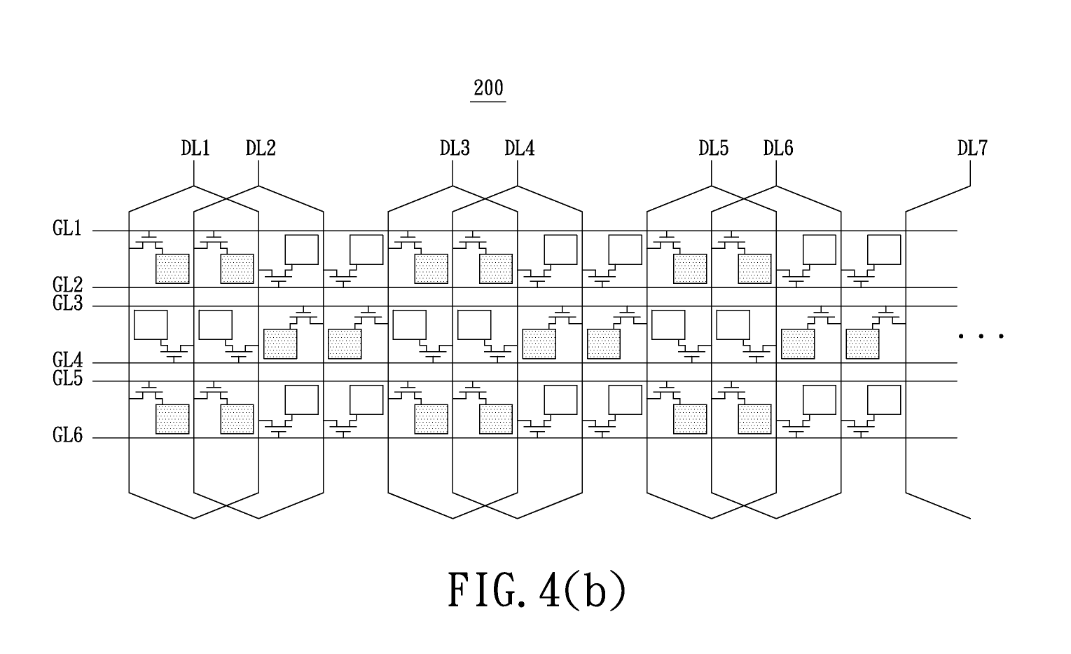

Referring to FIGS. 2 and 3, showing timing diagrams of the start pulse signals ST1, ST2, the clock signals CK1˜CK4 and the gate driving signals G1˜G6 associated with the gate driving circuit 10 being applied to a HSD display. In the illustrated embodiment, since the start pulse signals ST1 and ST2 are mutually independent from each other, time sequences of the start pulse signals ST1, ST2 can be flexibly set. Moreover, the start pulse signals ST1 and ST2 generally are single-pulse signals. As illustrated in FIG. 2, when the start pulse signal ST1 inputted into the first group of shift register stage is set to be prior to the start pulse signal ST2 inputted into the second group of shift register stage, an output order of the gate driving signals G1˜G6 is the same as the arranging order of the shift register stages SR1˜SR6, i.e., the gate driving signals G1˜G6 are sequentially outputted. Whereas, as illustrated in FIG. 3, when the start pulse signal ST1 inputted into the first group of shift register stage is set to be posterior to the start pulse signal ST2 inputted into the second group of shift register state, an output order of the gate driving signal G1˜G6 is different from the arranging order of the shift register stages SR1˜SR6 and in particular, the gate driving signal G2 is outputted prior to G1, G4 is outputted prior to G3, G6 is outputted prior to G5, and so forth. Herein, the gate driving circuit 10 can be applied to a HSD display 200 as illustrated in FIG. 4.

More specifically, FIG. 4 shows a partial schematic circuit diagram of the HSD display 200. As illustrated in FIG. 4, the HSD display 200 includes a plurality of pixels (not labeled), a plurality of gate lines e.g., GL1˜GL6 respectively for receiving the gate driving signals G1˜G6, and a plurality of data lines DL1˜DL7. The pixels are electrically connected to the respective gate lines GL1˜GL6 and data lines DL1˜DL7. Each of the pixels generally includes a thin film transistor and a pixel electrode electrically connected to the thin film transistor.

FIG. 4(a) shows a display state of the HSD display 200 displaying an odd image frame and using the gate driving signals G1˜G6 of FIG. 2. At the moment, the start pulse signal ST1 is prior to the start pulse signal ST2, the gate driving signal G1 is outputted prior to G2 which controls the same pixel row with G1, likewise the gate driving signal G3 is outputted prior to G4 which controls the same pixel row with G3, G5 is outputted prior to G6. Accordingly, a brightness of the pixels (i.e., the grey pixels as illustrated in FIG. 4(a)) electrically connected to the gate lines GL2, GL4 and GL6 relative to a brightness of the pixels electrically connected to the gate lines GL1, GL3 and GL5 is darker.

FIG. 4(b) shows another display state of the HSD display 200 displaying an even image frame and using the gate driving signals G1˜G6 of FIG. 3. At the moment, the start pulse signal ST1 is posterior to the start pulse signal ST2, the gate driving signal G2 is outputted prior to G1 which controls the same pixel row with G2, likewise the gate driving signal G4 is outputted prior to G3 which controls the same pixel row with G4, G6 is outputted prior to G5. Accordingly, a brightness of the pixels electrically connected to the gate lines GL2, GL4 and GL6 relative to a brightness of the pixels (i.e., the grey pixels as illustrated in FIG. 4(b)) electrically connected to the gate lines GL1, GL3 and GL5 is brighter.

In short, during the HSD display 200 displaying each two adjacent image frames, by interchanging priority orders of the start pulse signals ST1 and ST2 one time, display bright spots of the HSD display 200 would be homogenized in time domain, and therefore the vertical line mura associated with the prior art is effectively relieved.

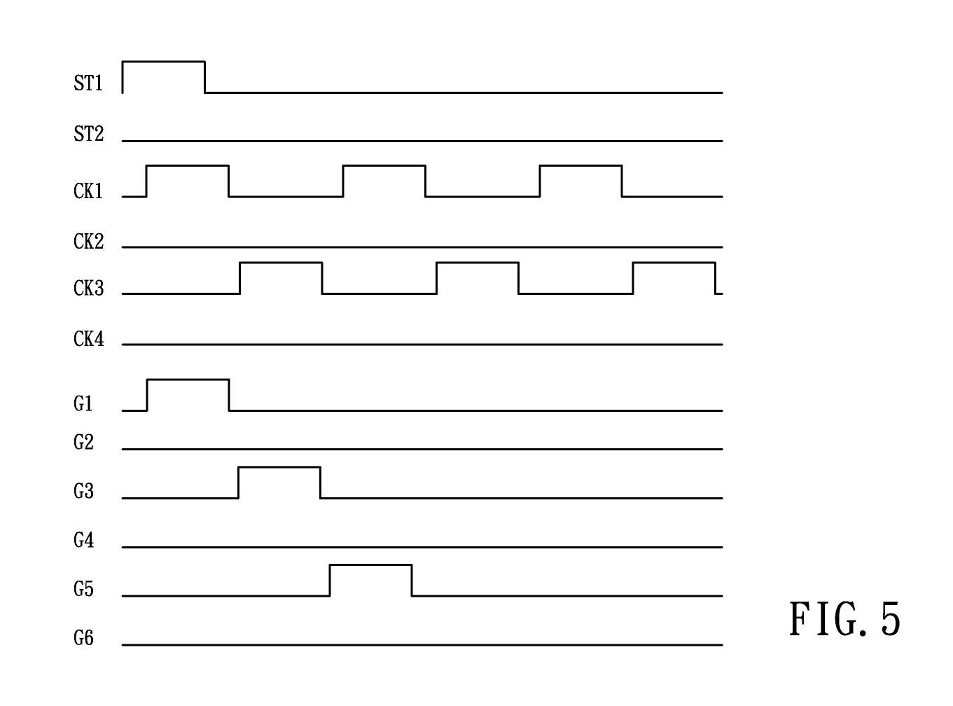

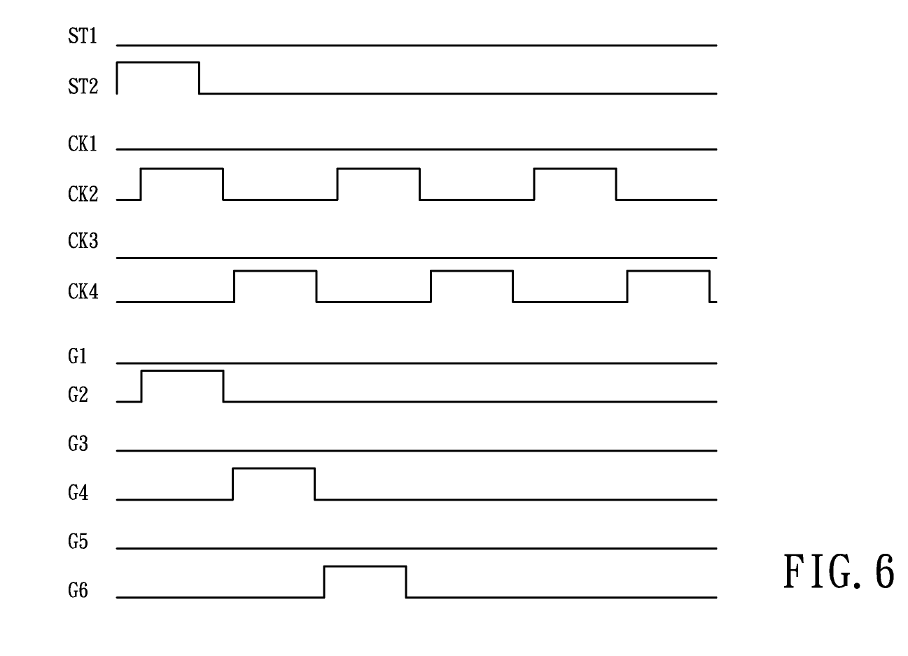

Referring to FIGS. 5 and 6, showing timing diagrams of the start pulse signals ST1 and ST2, the clock signals CK1˜CK4 and the gate driving signals G1˜G6 associated with the gate driving circuit 10 being applied to an interlace display. In the illustrated embodiment, since the start pulse signals ST1 and ST2 are mutually independent from each other, one of the start pulse signals ST1, ST2 can be disabled during the interlace display displaying an odd or even image frame. For example, as illustrated in FIG. 5, when displaying an odd image frame, the start pulse signal ST1 is enabled and the start pulse signal ST2 is disabled to input, correspondingly the shift register stages SR1, SR3, SR5 of the first group of shift register stage sequentially output the gate driving signals G1, G3 and G5, the shift register stages SR2, SR4, SR6 of the second group of shift register stage would not output any gate driving signal. At this moment, the two-phase clock signals CK2, CK4 associated with the second group of shift register stage also can be disabled. As illustrated in FIG. 6, when displaying an even image frame, the start pulse signal ST2 is enabled and the start pulse signal ST1 is disabled to input, correspondingly the shift register stages SR1, SR3, SR5 of the first group of shift register stage would not output any gate driving signal, the shift register stages SR2, SR4, SR6 of the second group of shift register stage sequentially output the gate driving signals G2, G4 and G6. At this moment, the two-phase clock signals CK1, CK3 also can be disabled.

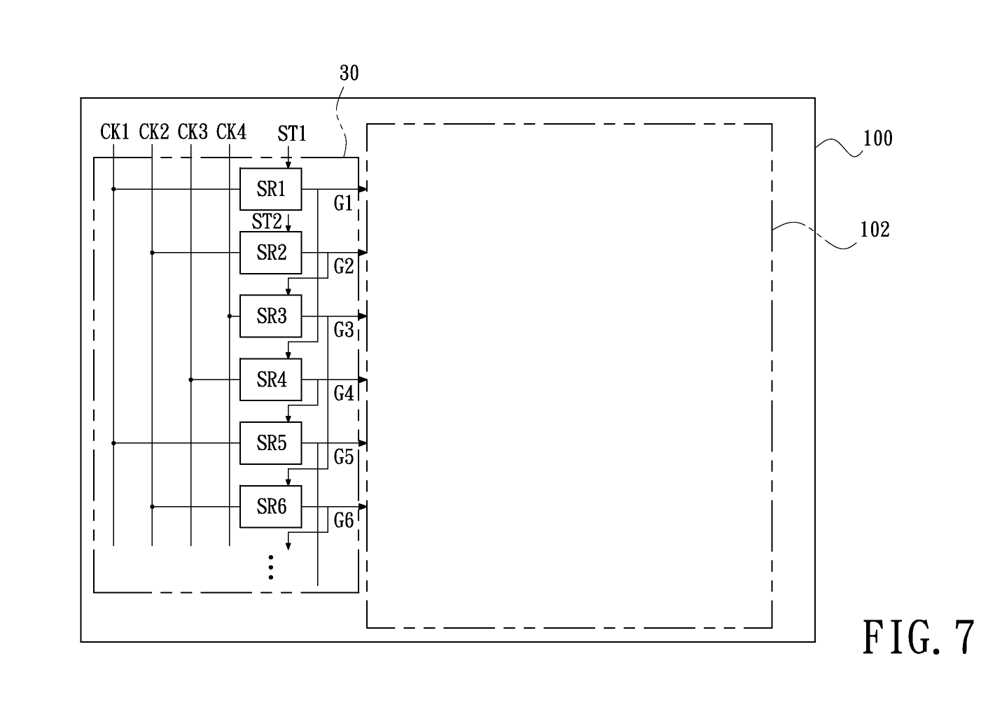

Referring to FIG. 7, a gate driving circuit 30 in accordance with another embodiment of the present invention is formed on a substrate 100. The substrate 100 generally has a thin film transistor array formed thereon. As illustrated in FIG. 7, the gate driving circuit 30 includes a plurality of shift register stages e.g., SR1˜SR6 successively arranged on the substrate 100 along the vertical direction and for outputting a plurality of gate driving signals e.g., G1˜G6. The shift register stages SR1˜SR6 are grouped into two groups. The shift register stages SR1, SR4 and SR5 belong to a first group of the two groups and herein are referred to as first shift register stages for convenience of description. The shift register stages SR2, SR3 and SR6 belong to a second group of the two groups and herein are referred to as second shift register stages. The first shift register stages SR1, SR4, SR5 and the second shift register stages SR2, SR3, SR6 are arranged along the vertical direction in alternating fashion and cooperatively constitute a plurality of first repeating units and a plurality of second repeating units. The first repeating units and the second repeating units are alternately arranged along the vertical direction. Each of the first and second repeating units includes one of the first group of shift register stage and one of the second group of shift register stage. A relative positional relationship of the first and second shift register stages of each of the first repeating units is different from a relative positional relationship of the first and second shift register stages of each of the second repeating units. For example, the relative positional relationship of the first shift register stage SR1 and the second shift register stage SR2 is different from the first shift register stage SR4 and the second shift register stage SR3.

The first group of shift register stage uses a start pulse signal ST1 and two-phase clock signals CK1, CK3. The first shift register stages SR1, SR4 and SR5 of the first group are connected in cascade. The second group of shift register stage uses a start pulse signal ST2 and two-phase clock signals CK2, CK4. The second shift register stages SR2, SR3 and SR6 of the second group are connected in cascade. In other words, the start pulse signal ST1 and the two-phase clock signals CK1, CK3 used by the first group of shift register stage respectively are mutually independent from the start pulse signal ST2 and two-phase clock signals CK2, CK4 used by the second group of shift register stage.

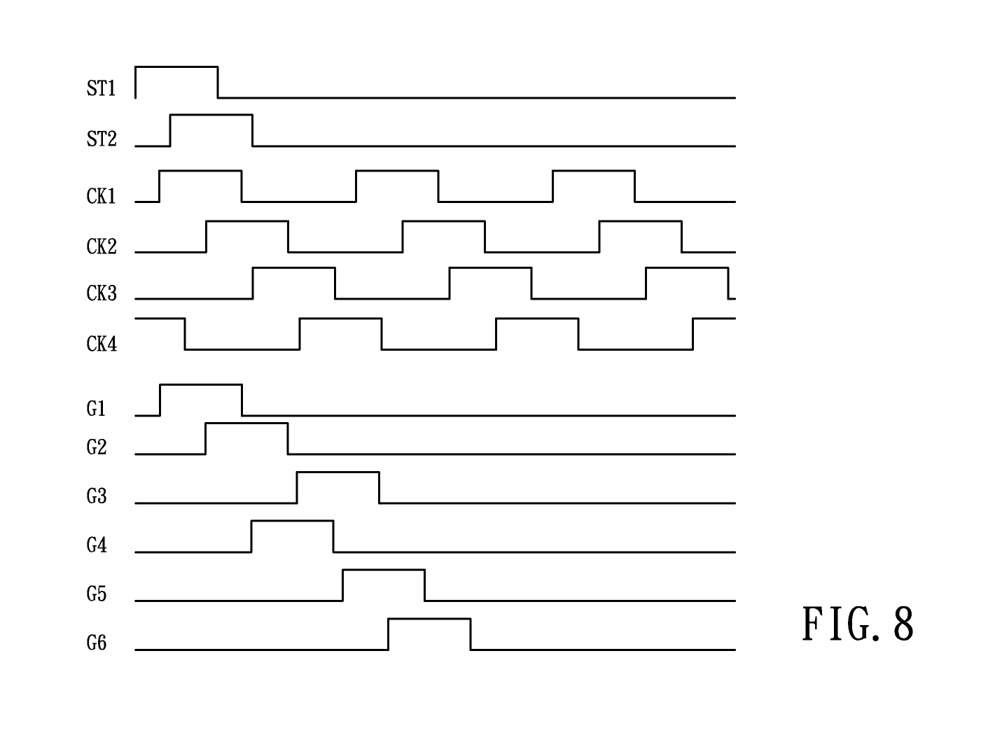

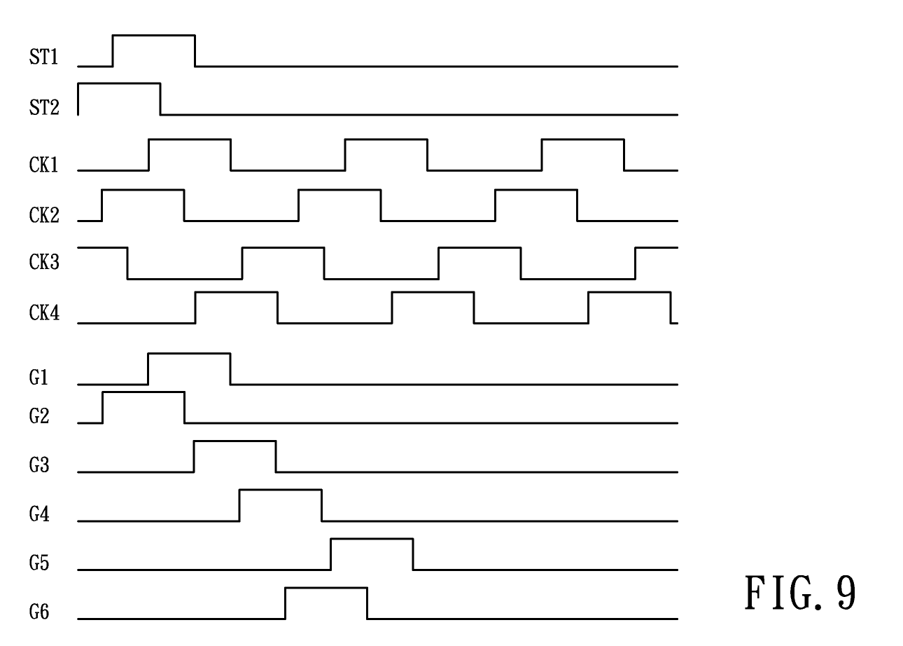

Referring to FIGS. 8 and 9, showing timing diagrams of the start pulse signals ST1 and ST2, the clock signals CK1˜CK4 and the gate driving signals G1˜G6 associated with the gate driving circuit 30 being applied to a HSD display. In the illustrated embodiment, since the start pulse signals ST1 and ST2 are mutually independent from each other, time sequences of the start pulse signals ST1, ST2 can be flexibly set.

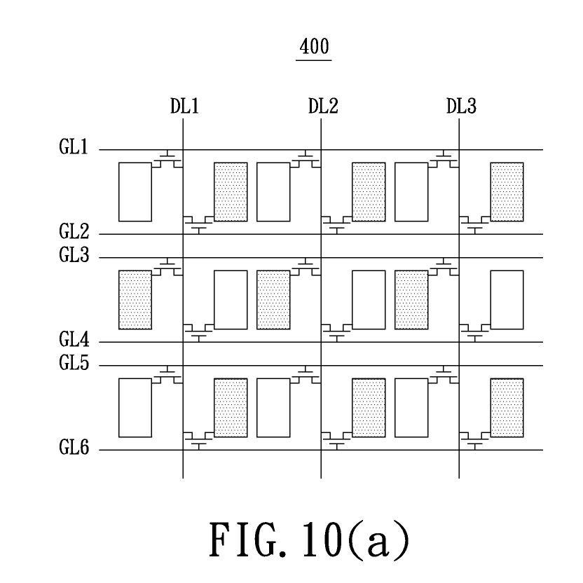

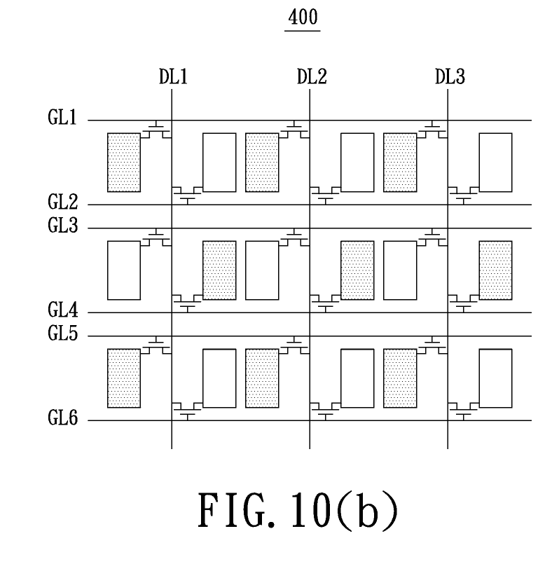

As illustrated in FIG. 8, when the start pulse signal ST1 inputted into the first group of shift register stage is set to be prior to the start pulse signal ST2 inputted into the second group of shift register stage, an output order of the gate driving signals G1˜G6 is different from the arranging order of the shift register stages SR1˜SR6 and in particular, the gate driving signal G1 is outputted prior to G2, G3 is outputted posterior to G4, G5 is outputted prior to G6, and so on. Whereas, as illustrated in FIG. 9, when the start pulse signal ST1 inputted into the first group of shift register stage is set to be posterior to the start pulse signal ST2 inputted into the second group of shift register stage, an output order of the gate driving signals G1˜G6 still is different from the arranging order of the shift register stages SR1˜SR6 and in particular, the gate driving signal G1 is outputted posterior to G2, G3 is outputted prior to G4, G5 is outputted posterior to G6, and so forth. Herein, the gate driving circuit 30 can be applied into a HSD display 400 as illustrated in FIG. 10.

FIG. 10 shows a partial schematic circuit diagram of the HSD display 400. As illustrated in FIG. 10, the HSD display 400 includes a plurality of pixels (not labeled), a plurality of gate lines GL1˜GL6 respectively for receiving the gate driving signals G1˜G6, and a plurality of data lines DL1˜DL3. The pixels are electrically connected to the respective gate lines GL1˜GL6 and data lines DL1˜DL3. Each of the pixels includes a thin film transistor and a pixel electrode electrically connected to the thin film transistor.

FIG. 10(a) shows a display state of the HSD display 400 displaying an odd image frame and using the gate driving signals G1˜G6 of FIG. 8. At this situation, the start pulse signal ST1 is prior to the start pulse signal ST2, the gate driving signal G1 is outputted prior to G2 which controls the same pixel row with G1, the gate driving signal G3 is outputted posterior to G4 which controls the same pixel row with G3, G5 is outputted prior to G6, and so on. Accordingly, a brightness of the pixels (i.e., the grey pixels as illustrated in FIG. 10(a)) electrically connected to the gate lines GL2, GL3 and GL6 relative to a brightness of the pixels electrically connected to the gate lines GL1, GL4 and GL5 is darker.

FIG. 10(b) shows another display state of the HSD display 400 displaying an even image frame and using the gate driving signals G1˜G6 of FIG. 9. At this circumstance, the start pulse signal ST1 is posterior to the start pulse signal ST2, the gate driving signal G1 is outputted posterior to G2 which controls the same pixel row with G1, the gate driving signal G3 is outputted prior to G4 which controls the same pixel row with G3, G5 is outputted posterior to G6, and so forth. Accordingly, a brightness of the pixels electrically connected to the gate lines GL2, GL3 and GL6 relative to a brightness of the pixels (i.e., the grey pixels as illustrated in FIG. 10(b)) is brighter.

In short, during the HSD display 400 displaying each two adjacent image frames, by interchanging priority orders of the start pulse signals ST1 and ST2 one time, display bright spots of the HSD display 400 are homogenized in both time and spatial domains, and therefore the vertical line mura associated with the prior art can be effectively relieved.

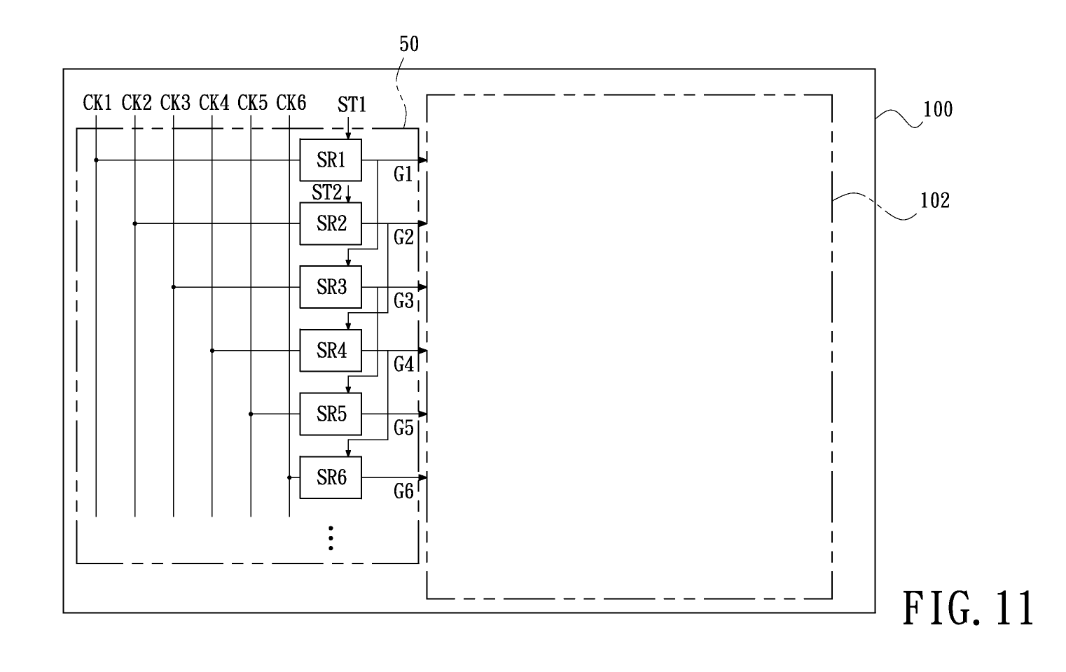

Referring to FIG. 11, a gate driving circuit 50 in accordance with still another embodiment of the present invention is formed on a substrate 100. The substrate 100 generally has a thin film transistor array 102 formed thereon. As illustrated in FIG. 11, the gate driving circuit 50 includes a plurality of shift register stages e.g., SR1˜SR6 successively arranged on the substrate 100 along the vertical direction and for outputting a plurality of gate driving signals e.g., G1˜G6. The shift register stages SR1˜SR6 are grouped into two groups. The shift register stages SR1, SR3 and SR5 belong to a first group of the two groups and herein are referred to first shift register stages for convenience of description. The shift register stages SR2, SR4 and SR6 belong to a second group of the two groups and herein are referred to as second shift register stages. The first shift register stages SR1, SR3, SR5 and the second shift register stages SR2, SR4, SR6 are alternately arranged and constitute a plurality of repeating units successively arranged along the vertical direction. Each of the repeating units includes one of the first group of shift register stage (e.g., SR1) and one of the second group of shift register stage (e.g., SR2).

The first group of shift register stage uses a start pulse signal ST1 and three-phase clock signals CK1, CK3 and CK5. The first shift register stages SR1, SR3 and SR5 of the first group are connected in cascade. The second group of shift register stage uses a start pulse signal ST2 and three-phase clock signals CK2, CK4 and CK6. The second shift register stages SR2, SR4 and SR6 of the second group are connected in cascade. In other words, the start pulse signal ST1 and the three-phase clock signals CK1, CK3, CK5 used by the first group of shift register stage respectively are mutually independent from the start pulse signal ST2 and the three-phase clock signals CK2, CK4, CK6.

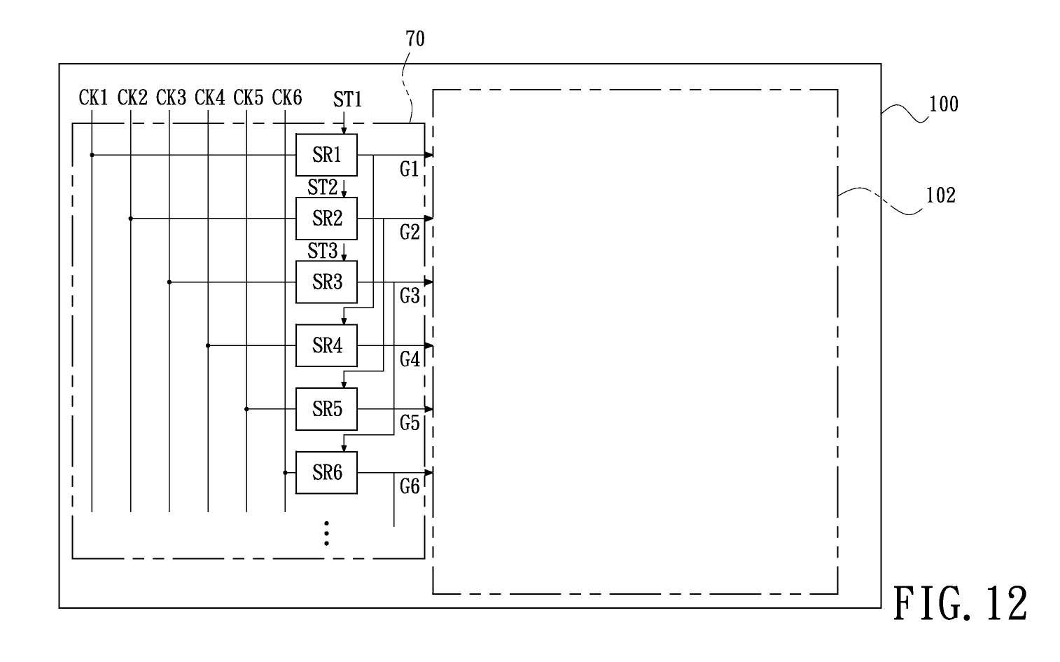

Referring to FIG. 12, a gate driving circuit 70 in accordance with even still another embodiment of the present invention is formed on a substrate 100. The substrate 100 generally has a thin film transistor array 102 formed thereon. As illustrated in FIG. 12, the gate driving circuit 70 includes a plurality of shift register stages e.g., SR1˜SR6 successively arranged on the substrate 100 along the vertical direction and for outputting a plurality of gate driving signals G1˜G6. The shift register stages SR1˜SR6 are grouped into three groups. The shift register stages SR1 and SR4 belong to a first group of the three groups and herein are referred to as first shift register stages for convenience of description. The shift register stages SR2 and SR5 belong to a second group of the three groups and herein are referred to as second shift register stages. The shift register stages SR3 and SR6 belong to a third group of the three groups and herein are referred to third shift register stages. The first shift register stages SR1, SR4, the second shift register stages SR2, SR5 and the third shift register stages SR3, SR6 constitute a plurality of repeating units successively arranged along the vertical direction. Each of the repeating units includes one of the first group of shift register stage (e.g., SR1), one of the second group of shift register stage (e.g., SR2) and one of the third group of shift register stage (e.g., SR3).

The first group of shift register stage uses a start pulse signal ST1 and two-phase clock signals CK1, CK4. The first shift register stages SR1 and SR4 of the first group are connected in cascade. The second group of shift register stage uses a start pulse signal ST2 and two-phase clock signals CK2, CK5. The second shift register stages SR2 and SR5 of the second group are connected in cascade. The third group of shift register stage uses a start pulse signal ST3 and two-phase clock signals CK3, CK6. The third shift register stage SR3 and SR6 of the third group are connected in cascade. In other words, the start pulse signal ST1 and the two-phase clock signals CK1, CK4 used by the first group of shift register stage, the start pulse signal ST2 and the two-phase clock signals CK2, CK5 used by the second group of shift register stage, and the start pulse signal ST3 and the two-phase clock signals CK3, CK6 are mutually independent from one another.

It is noted that the groups of shift register stage in the gate driving circuit associated with the embodiments of the present invention are not limited to be arranged at one side of the thin film transistor array 102 on the substrate 100, and may be arranged at both sides of the thin film transistor array 102. Moreover, the amount of the shift register stages in the gate driving circuit associated with the embodiments of the present invention is not limited to be six and may be any number satisfying the requirement of actual application. Additionally, the skilled person in the art can make some modifications with respect to the gate driving circuit in accordance with the above-mentioned embodiments, for example, suitably changing the amount of the groups of shift register stage in the gate driving circuit, and/or the amount of the clock signals, as long as such modification(s) would not depart from the scope and spirit of the present invention.

In summary, the shift register stages of the gate driving circuit in the above-mentioned embodiments of the present invention are grouped, the start pulse signal and multi-phase clock signals used by one of the groups respectively are independent from that used by any one of the other group(s), therefore the user can flexibly adjust the priority orders of the start pulse signals used by the respective groups or disable one of the start pulse signals. Accordingly, when the gate driving circuit proposed by the present invention is applied to a HSD display, the vertical line mura associated with the prior art can be effectively relieved. Furthermore, the application range of the gate driving circuit proposed by the present invention can expand to interlace displays.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A gate driving circuit, formed on a substrate and comprising:
a plurality of shift register stages successively arranged on the substrate along a predetermined direction, wherein the shift register stages are grouped into a plurality of groups and for outputting a plurality of gate driving signals, each of the groups comprises a plurality of cascade-connected the shift register stages;
wherein time sequences of a plurality of start pulse signals used by the respective groups are different from one another, and an output order of the gate driving signals is different from the arranging order of the shift register stages.

2. The gate driving circuit as claimed in claim 1, wherein the shift register stages constitute a plurality of repeating units in the predetermined direction, the repeating units being successively arranged along the predetermined direction, each of the repeating units comprising one of the cascade-connected shift register stages of each of the groups.

3. The gate driving circuit as claimed in claim 2, wherein each of the groups uses multi-phase clock signals, the multi-phase clock signals used by each of the groups are different from the multi-phase clock signals used by any one of the other group(s).

4. The gate driving circuit as claimed in claim 3, wherein the amount of the groups is two, and the multi-phase clock signals used by each of the two groups are two-phase clock signals.

5. The gate driving circuit as claimed in claim 4, wherein when the gate driving circuit is applied to a half source driving display, priority orders of the start pulse signals inputted into the respective groups are interchanged one time during the half source driving display displaying each two adjacent image frames.

6. The gate driving circuit as claimed in claim 4, wherein when the gate driving circuit is applied to an interlace display, one of the start pulse signals is disabled during the interlace display displaying each image frame.

7. The gate driving circuit as claimed in claim 3, wherein the amount of the groups is two, and the multi-phase clock signals used by each of the two groups are three-phase clock signals.

8. The gate driving circuit as claimed in claim 4, wherein the amount of the groups is three, and the multi-phase clock signals used by each of the three groups are two-phase clock signals.

9. The gate driving circuit as claimed in claim 1, wherein the shift register stages constitute a plurality of first repeating units and a plurality of second repeating units in the predetermined direction, the first repeating units and the second repeating units being alternately arranged along the predetermined direction, each of the first and second repeating units comprises one of the cascade-connected shift register stages of each of the groups, a relative positional relationship of the shift register stages of each of the first repeating units and belonging to the respective groups is different from a relative positional relationship of the shift register stages of each of the second repeating units and belonging to the respective groups.

10. The gate driving circuit as claimed in claim 9, wherein the amount of the groups is two, and each of the two groups uses two-phase clock signals.

11. The gate driving circuit as claimed in claim 10, wherein when the gate driving circuit is applied to a half source driving display, priority orders of the start pulse signals inputted into the respective groups are interchanging one time during the half source driving display displaying each two adjacent image frames.

12. A gate driving circuit, formed on a substrate and comprising:
a plurality of shift register stages, wherein the shift register stages are successively arranged on the substrate along a predetermined direction and grouped into a plurality of groups, each of the groups comprises a plurality of cascade-connected the shift register stages;
wherein the groups use a plurality of start pulse signals, a priority order of one of the start pulse signals used by each of the groups relative to another one of the start pulse signals used by any one of the other group(s) is adjustable;
wherein each of the groups and any one of the other group(s) does not use the same clock signal.

13. The gate driving circuit as claimed in claim 12, wherein the cascade-connected shift register stages of each of the groups and the cascade-connected shift register stages of any one of the other group(s) are alternately arranged along the predetermined direction.

14. The gate driving circuit as claimed in claim 13, wherein the amount of the groups is two, and each of the two groups uses two-phase clock signals.

15. The gate driving circuit as claimed in claim 14, wherein when the gate driving circuit is applied to a half source driving display, priority orders of the start pulse signals inputted into the respective groups are interchanged one time during the half source driving displaying each two adjacent image frames.

16. The gate driving circuit as claimed in claim 14, wherein when the gate driving circuit is applied to an interlace display, one of the start pulse signals is disabled during the interlace display displaying each image frame.

17. The gate driving circuit as claimed in claim 13, wherein the amount of the groups is two, and each of the two groups uses three-phase clock signals.

18. The gate driving circuit as claimed in claim 13, wherein the amount of the groups is three, and each of the three groups uses two-phase clock signals.

19. The gate driving circuit as claimed in claim 12, wherein the shift register stages constitute a plurality of first repeating units and a plurality of second repeating units in the predetermined direction, the first repeating units and the second repeating units being alternately arranged along the predetermined direction, each of the first and second repeating units comprises one of the cascade-connected shift register stages of each of the groups, a relative positional relationship of the shift register stages of each of the first repeating units and belonging to the respective groups is different from a relative positional relationship of the shift register stages of each of the second repeating units and belonging to the respective groups.

20. The gate driving circuit as claimed in claim 19, wherein the amount of the groups is two, and each of the two groups uses two-phase clock signals.

21. The gate driving circuit as claimed in claim 20, wherein when the gate driving circuit is applied to a half source driving display, priority orders of the start pulse signals inputted into the respective groups are interchanged one time during the half source driving display displaying each two adjacent image frames.
